(19) United States
(12) Patent Application Publication
(10) Pub. No.: US 2025/0202159 A1
(43) Pub. Date: Jun. 19, 2025

(54) CONNECTOR DEVICE

(71) Applicant: Mitsubishi Electric Corporation, Tokyo (JP)

(72) Inventor: Yoshitsugu HIRAYAMA, Tokyo (JP)

(73) Assignee: Mitsubishi Electric Corporation, Tokyo (JP)

(21) Appl. No.: 18/849,634

(22) PCT Filed: Oct. 5, 2022
(86) PCT No.: PCT/JP2022/037245

§ 371 Date: Sep. 23, 2024

(30) Foreign Application Priority Data
Apr. 27, 2022 (JP) 2022-072897

(51) Int. Cl. H01R 13/52; H01R 13/73

(52) U.S. Cl. CPC H01R 13/5202; H01R 13/73; H01R 2201/26

(57) ABSTRACT

A connector device includes: a housing in which a connector is provided; and a circuit board which transmits information from an electronic device fixed inside the housing. The connector has a seal packing for waterproofing, a connection terminal to be connected to an external circuit, a connection terminal to be connected to the circuit board, and a position setting determination portion to determine a set position relative to the housing. The housing has a fit-in hole into which an end of the connector is fitted, and a positioning portion to determine a placement position of the connector on the housing. The connector is fixed by being fitted into the fit-in hole of the housing with the seal packing interposed therebetween, and a position of the connector relative to the housing is set by the position setting determination portion of the connector and the positioning portion of the housing.

### TECHNICAL FIELD

The present disclosure relates to a connector device.

### BACKGROUND ART

As a method for reducing the cost of an electronic device such as a vehicular inverter, there is a method in which a harness (wire harness) connecting a circuit board inside the inverter and an external interface is removed and a board direct-joining connector for directly joining the board and the connector is used. As a positioning method in joining the board and the connector, there is a method in which, first, the connector and the circuit board are joined, and then, attachment of a housing and the connector is performed using a separate member in order to prevent variation in the attachment and reduction in waterproof seal performance (see, for example, Patent Document 1).

### CITATION LIST

### Patent Document

Patent Document 1: Japanese Patent No. 4153549

### SUMMARY OF THE INVENTION

### Problem to be Solved by the Invention

However, the conventional method has the following problems.

In a case of omitting a cover used for attaching a waterproof seal in Patent Document 1 for the purpose of reducing the number of parts, it is necessary to attach the housing and the connector in advance, in order to ensure waterproofness. The positioning accuracy of the connector is influenced by the attachment method for the connector and the housing, and therefore, depending on error in attachment, attachment position error of a terminal joined to the circuit board increases, so that there is a possibility that the circuit board cannot be attached.

In addition, for attaching the connector, it may be necessary to further perform a working step of rotating the housing in a screwing direction.

The present disclosure has been made to solve the above problem, and an object of the present disclosure is to make it possible to provide a connector device that allows positioning of a housing and a connector to be performed without increasing the number of parts, while ensuring waterproofness of a connector device, and enables attachment of the connector in the same direction as the direction in which a circuit board is attached, thus shortening the takt time of an assembly line.

### Means to Solve the Problem

A connector device according to the present disclosure includes: a housing in which a connector is provided; and a circuit board which transmits information from an electronic device fixed inside the housing. The connector has a seal packing for waterproofing, a first connection terminal to be connected to an external circuit, a second connection terminal to be connected to the circuit board, and a position setting determination portion to determine a set position relative to the housing. The housing has a fit-in hole into which an end of the connector is fitted, and a positioning portion to determine a placement position of the connector on the housing. The connector is fixed by being fitted into the fit-in hole of the housing with the seal packing interposed therebetween, and a position of the connector relative to the housing is set by the position setting determination portion of the connector and the positioning portion of the housing.

### Effect of the Invention

A connector device according to the present disclosure makes it possible to provide a connector device that allows positioning of a housing and a connector to be performed without increasing the number of parts, while ensuring waterproofness of a connector device, and enables attachment of the connector in the same direction as the direction in which a circuit board is attached, thus shortening the takt time of an assembly line.

### BRIEF DESCRIPTION OF THE DRAWINGS

FIG. 1A is a side view of a connector device according to embodiment 1.

FIG. 1B is a perspective view of the connector device according to embodiment 1.

FIG. 2A is a front view of a connector of the connector device according to embodiment 1.

FIG. 2B is a perspective view of the connector of the connector device according to embodiment 1.

FIG. 3 is a perspective view of a housing of the connector device according to embodiment 1.

FIG. 4 is a perspective view illustrating a positioning method for the connector device according to embodiment 1.

FIG. 5 is a perspective view of a connector of a connector device according to embodiment 2.

FIG. 6 is a perspective view of a housing of the connector device according to embodiment 2.

FIG. 7A is a perspective view illustrating a positioning method for the connector device according to embodiment 2.

FIG. 7B is a sectional view illustrating the positioning method for the connector device according to embodiment 2.

FIG. 8A is a front view of a connector of a connector device according to embodiment 3.

FIG. 8B is a perspective view of the connector of the connector device according to embodiment 3.

FIG. 9 is a perspective view of a housing of the connector device according to embodiment 3.

FIG. 10 is a side view illustrating a positioning method for the connector device according to embodiment 3.

FIG. 11 is a perspective view of a connector of a connector device according to embodiment 4.

FIG. 12 is a perspective view of a housing of the connector device according to embodiment 4.

FIG. 13 is a perspective view illustrating a positioning method for the connector device according to embodiment 4.

FIG. 14 is a perspective view of a connector of a connector device according to embodiment 5.

FIG. 15 is a perspective view of a housing of the connector device according to embodiment 5.

FIG. 16 is a top view illustrating a positioning method for the connector device according to embodiment 5.

FIG. 17 is a perspective view of a connector of a connector device according to embodiment 6.

FIG. 18A is a sectional view illustrating a positioning method for the connector device according to embodiment 6.

FIG. 18B is a view for comparison with FIG. 18A.

FIG. 19 is a perspective view of a connector of a connector device according to embodiment 7.

FIG. 20 is a perspective view of a housing of the connector device according to embodiment 7.

FIG. 21 is a top view illustrating a positioning method for the connector device according to embodiment 7.

FIG. 22 is a perspective view of a bracket of a connector device according to embodiment 8.

FIG. 23 is a perspective view of a housing of the connector device according to embodiment 8.

FIG. 24 is a perspective view illustrating a positioning method for the connector device according to embodiment 8.

### DESCRIPTION OF EMBODIMENTS

### Embodiment 1

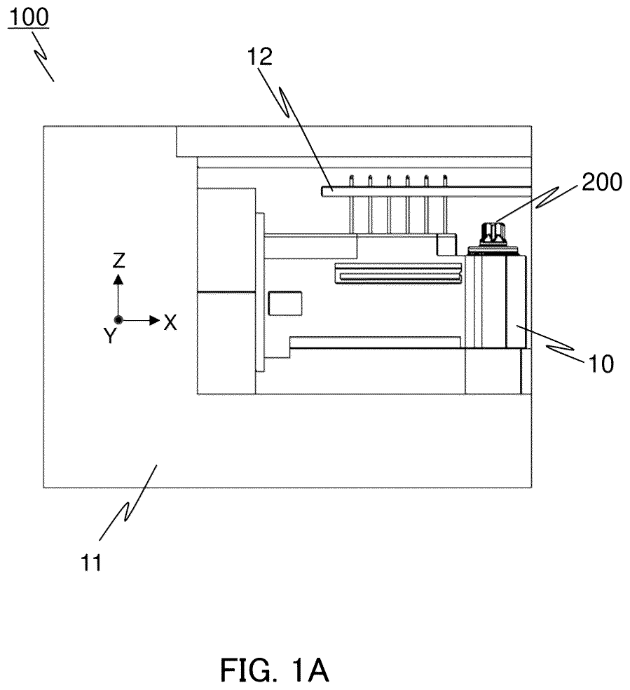

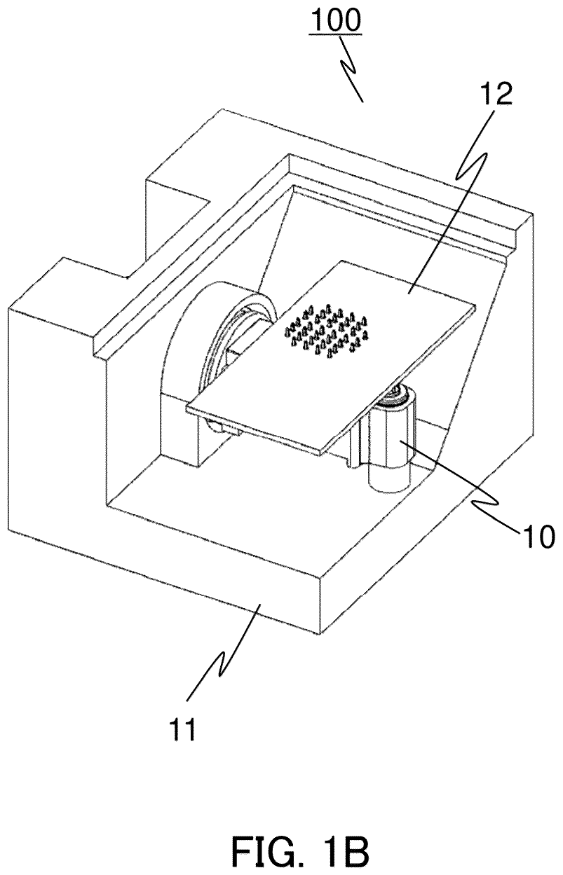

Hereinafter, a connector device according to embodiment 1 will be described with reference to FIG. 1A to FIG. 4. The connector device according to embodiment 1 is used as a connector for a vehicular electronic device, for example, and has waterproofness. In the drawings, the same or corresponding parts are denoted by the same reference characters and the description thereof is omitted.

The connector device 100 shown in FIG. 1A and FIG. 1B is, for example, provided to a vehicular inverter or the like, and serves a role of transmitting information by an electric signal between a vehicle and the inverter.

The connector device 100 shown in FIG. 1A and FIG. 1B is assembled such that, using a part of a housing 11 as a base for supporting a connector 10 (hereinafter, may be referred to as waterproof connector 10), the connector 10 is fixed to the housing by a screw 200 and then a circuit board 12 is attached.

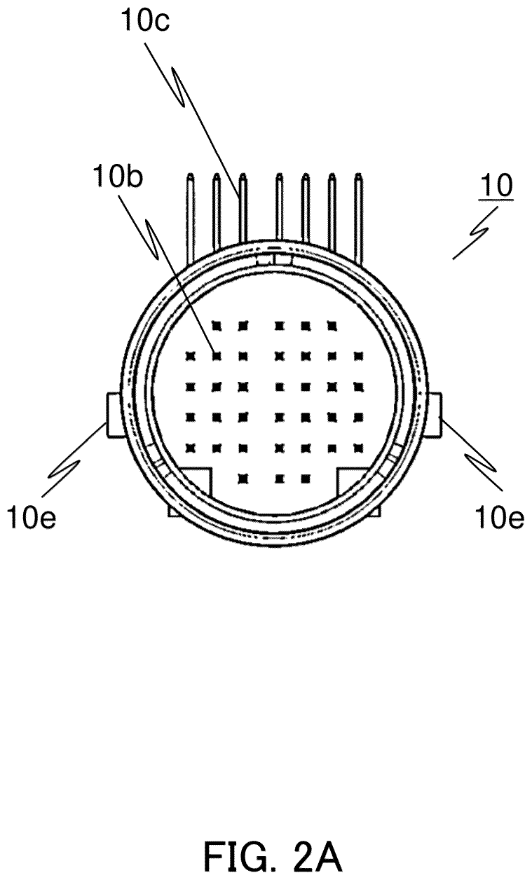

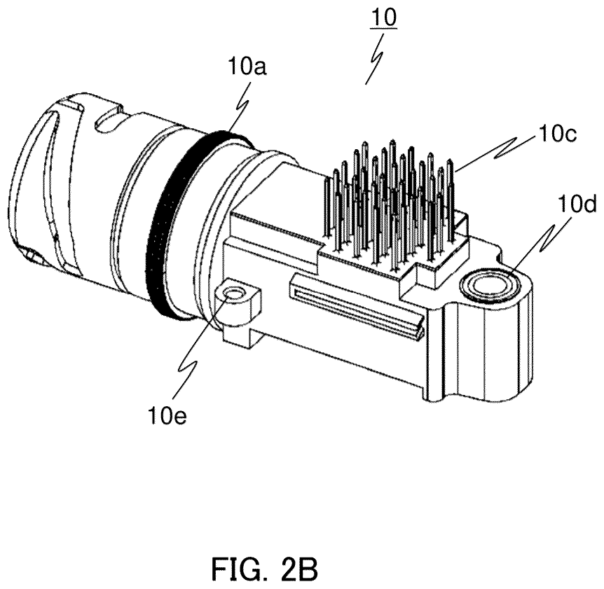

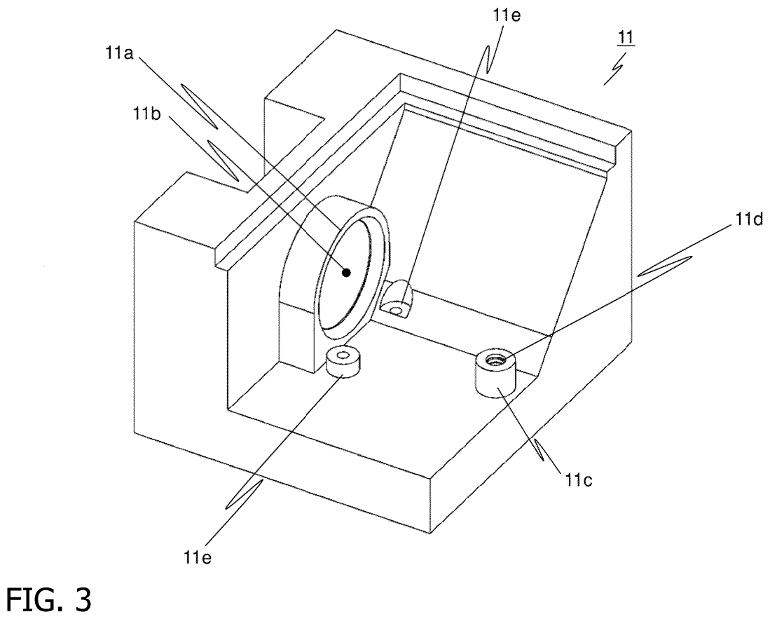

The waterproof connector 10 shown in FIG. 2A and FIG. 2B has a seal packing 10a, a connection terminal 10b to be electrically connected to an external connector, a connection terminal 10c to be electrically connected to the circuit board 12, a bush 10d for screw-fastening to the housing 11, and position setting determination portions 10e provided at two locations on side surfaces of the connector 10. Each position setting determination portion 10e has a vertical-direction hole (positioning hole) through which a positioning pin used generally is to be passed. The seal packing 10a of the connector 10 has a structure that ensures waterproofness by contacting with a seal surface 11b of the housing 11 shown in FIG. 3. The connection terminal 10b and the connection terminal 10c have an integrated structure and both are male connection terminals.

The housing 11 shown in FIG. 3 has a fit-in hole 11a into which the waterproof connector 10 is to be inserted, and the fit-in hole 11a has the seal surface 11b to contact with the seal packing 10a of the waterproof connector 10. A boss 11c has an internal thread 11d for screw-fastening to the waterproof connector 10, and a surface to oppose the bush 10d provided to the connector.

Here, the circuit board 12 (see FIG. 1B) used in the connector device of embodiment 1 is provided in the housing 11, and is electrically connected to the connection terminal 10c of the waterproof connector 10.

### Connector Positioning Method

Next, a positioning method for the connector 10 of the connector device 100 of embodiment 1 will be described with reference to FIG. 1A to FIG. 4.

For performing positioning for the connector 10, it is necessary to restrict movements in axial directions of X, Y, and Z axes and rotational movements about the axial directions of these axes. Hereinafter, in description of these directions, vector directions in the side view of the connector device 100 shown in FIG. 1A are used as a reference.

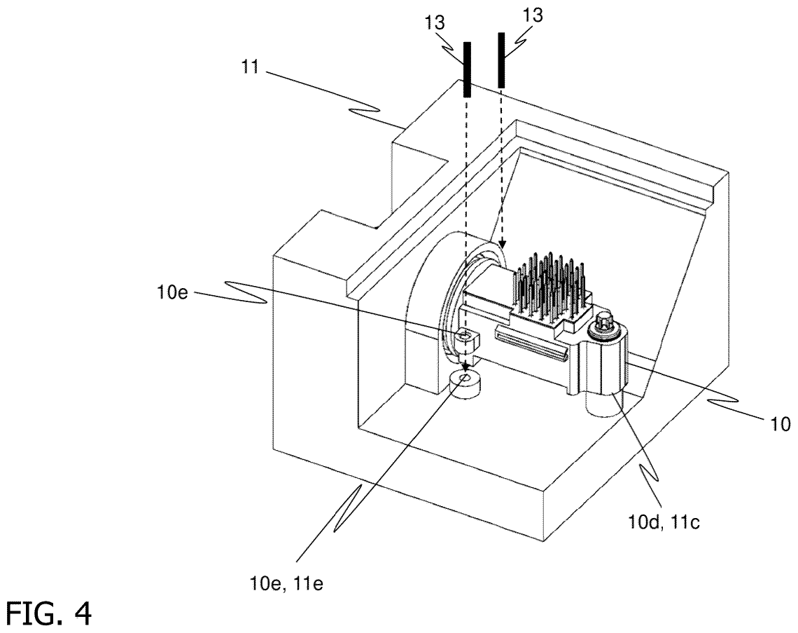

The waterproof connector 10 shown in FIG. 2A and FIG. 2B is attached such that the seal packing 10a contacts with the inner surface of the fit-in hole 11a of the housing 11 shown in FIG. 3 and the connection terminal 10c is directed in the Z direction. Positioning in the X direction, the Y direction, and the Z direction is made by inserting positioning pins 13 into the position setting determination portions 10e provided (at two locations) to the connector 10 and positioning portions 11e provided (at two locations) to the housing. A bottom surface of the bush 10d and a top surface (upper flat surface) of the boss 11c of the housing contact with each other and the screw 200 is fastened, whereby positions in the Z direction, the X-axis rotational (rotation about X axis) direction, and the Y-axis rotational (rotation about Y axis) direction, are determined (see FIG. 4).

### Embodiment 2

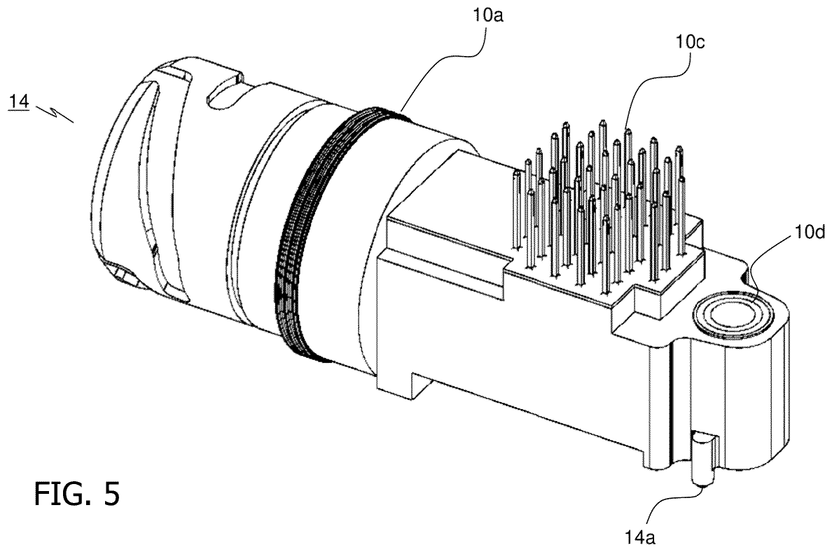

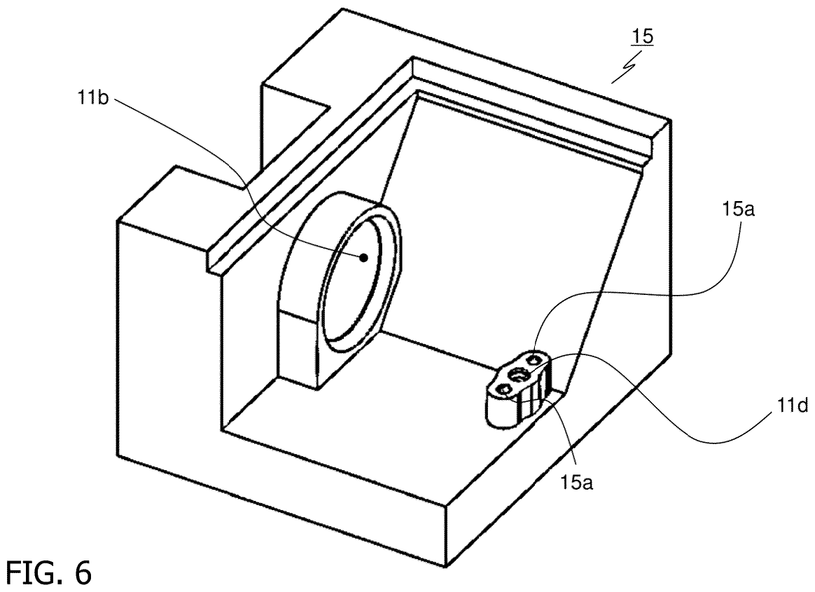

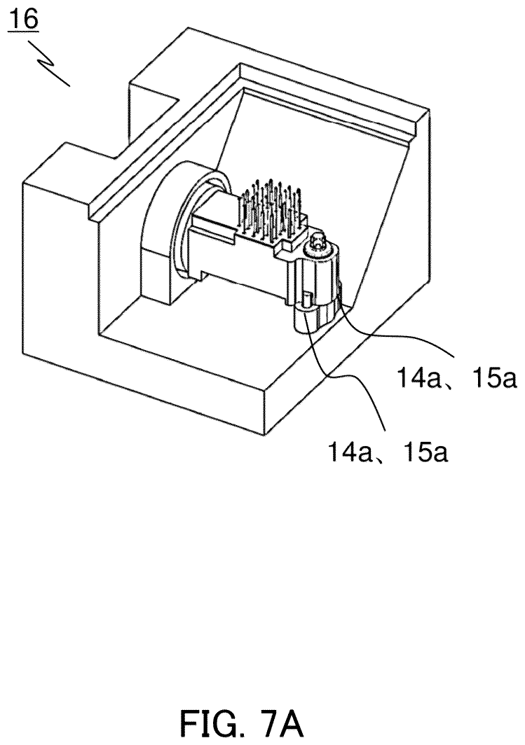

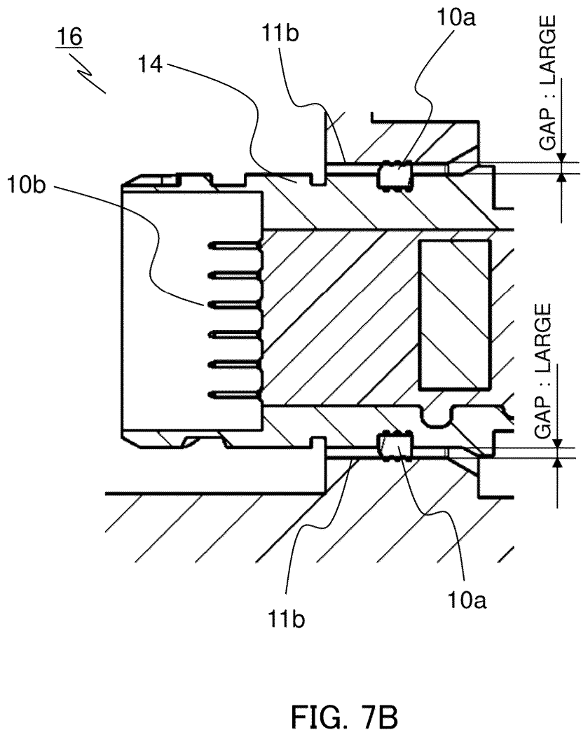

Hereinafter, a connector device 16 of embodiment 2 will be described with reference to FIG. 5, FIG. 6, FIG. 7A, and FIG. 7B. The basic structure of the connector device is the same as that of the connector device of embodiment 1 and therefore only difference will be described below.

FIG. 5 shows a connector 14 (hereinafter, may be referred to as waterproof connector 14) used for the connector device 16 of embodiment 2. As shown in FIG. 5, the waterproof connector 14 includes, as position setting determination portions, two positioning pins 14a having an axis extending in the Z direction (only one of them is shown in FIG. 5, but in actuality, another one is present at a line-symmetric position with respect to the axis of the bush 10d, totaling two).

A housing 15 used in embodiment 2 is shown in FIG. 6. The housing 15 includes two positioning holes 15a into which the positioning pins 14a are to be inserted.

A circuit board used in the connector device of embodiment 2 has the same structure as the circuit board used in the connector device of embodiment 1, and therefore the description thereof is omitted here.

### Connector Positioning Method

Hereinafter, a positioning method for the connector 14 of the connector device 16 of embodiment 2 will be described with reference to FIG. 7A and FIG. 7B.

Regarding positioning for the connector 14, as shown in a perspective view in FIG. 7A, the positioning pins 14a are inserted into the positioning holes 15a, whereby positions in the X direction, the Y direction, and the Z-axis rotation (rotation about Z axis) direction are determined. However, in a case where positioning is performed with the waterproof connector 14 attached to the housing 15, the positioning pins 14a extend in a direction to cause interference (direction in which it is difficult to perform positioning).

Accordingly, as a method for solving this, the waterproof connector 14 is fitted into the housing 15 while being tilted using a gap between the seal surface 11b and the waterproof connector 14 shown in a sectional view in FIG. 7B (in this case, as shown in FIG. 7B, the gap size is set to be large as appropriate in order to avoid the above interference), whereby the positioning pin 14a is inserted into the positioning hole 15a. The other positioning methods are the same as in the connector device of embodiment 1 and therefore the description thereof is omitted.

### Embodiment 3

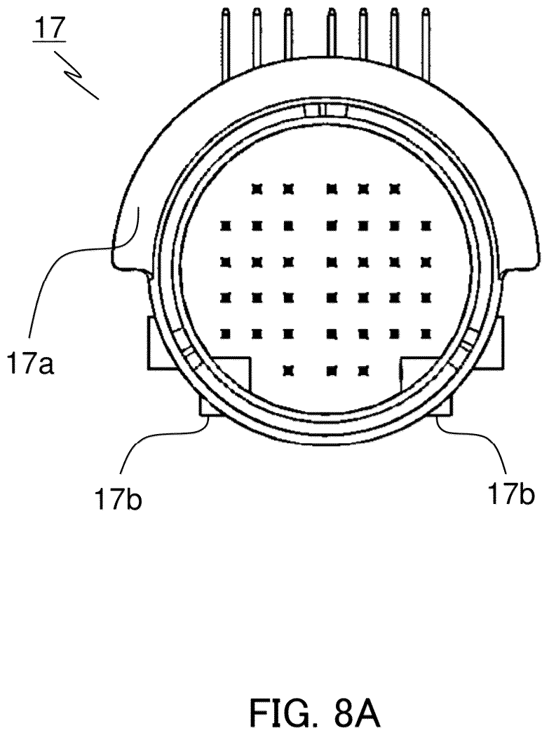

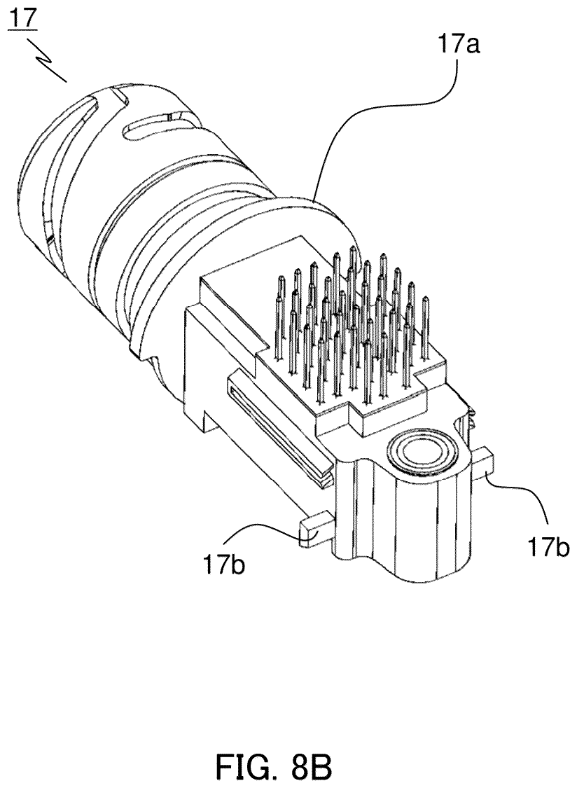

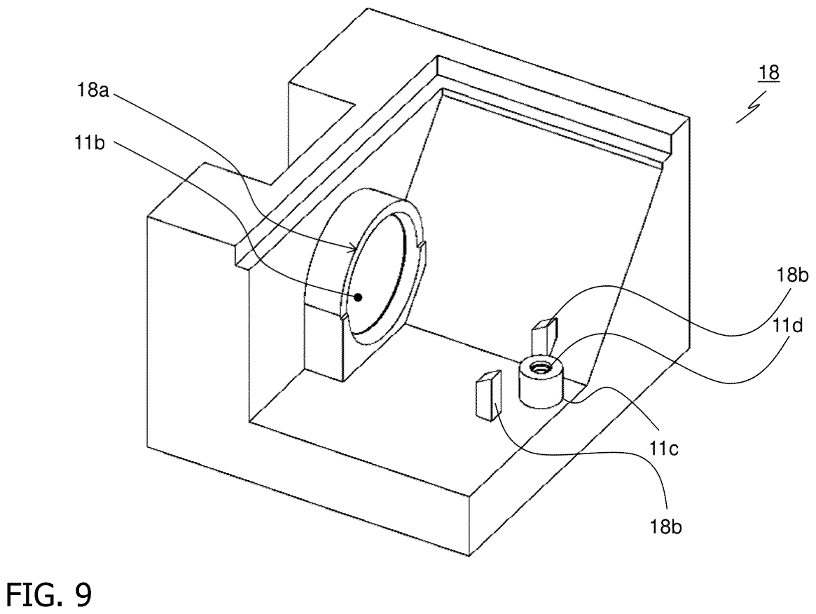

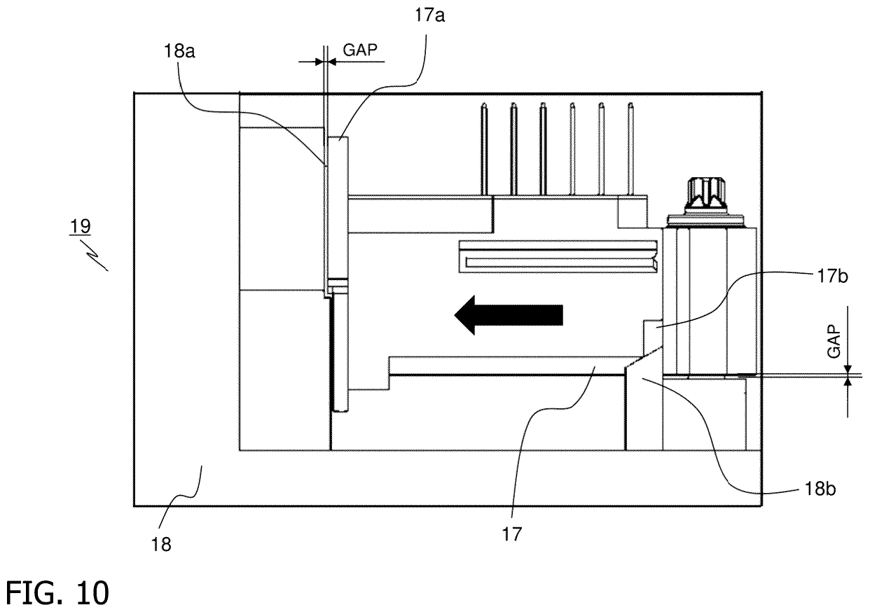

Hereinafter, a connector device of embodiment 3 will be described with reference to FIG. 8A, FIG. 8B, FIG. 9, and FIG. 10. The basic structure of the connector device is the same as that of the connector device of embodiment 1 and therefore only difference will be described below.

FIG. 8A and FIG. 8B illustrate a connector 17 (hereinafter, may be referred to as waterproof connector 17) used in the connector device of embodiment 3. Here, FIG. 8A is a front view of the connector of the connector device of embodiment 3, and FIG. 8B is a perspective view of the connector device of embodiment 3.

As shown in FIG. 8A and FIG. 8B, the connector includes, as position setting determination portions, a flange 17a provided on an outer periphery of the connector, and slope portions 17b provided at two locations on side surfaces.

FIG. 9 illustrates a housing 18 of the connector device of embodiment 3. As shown in FIG. 9, the housing 18 includes a surface 18a (cylindrical surface) to contact with the flange 17a, and slope portions 18b to contact with the slope portions 17b.

A circuit board of the connector device 19 of embodiment 3 has the same structure as the circuit board of the connector device of embodiment 1 and therefore the description thereof is omitted here.

### Connector Positioning Method

Hereinafter, a positioning method for the connector 17 of the connector device 19 of embodiment 3 will be described with reference to FIG. 10.

As shown in FIG. 10, when the connector device 19 is at a preset position, there is a gap between the flange 17a and the surface 18a and there is also a gap between the fastening bush 10d and the positioning portion 11e. When a screw is screwed in order to move the connector 17 to a set position, the contact surfaces of the slope portions 17b and the slope portions 18b slide on each other so that the connector moves in an arrow direction shown in FIG. 10. At this time, the flange 17a and the surface 18a contact with each other and the gap disappears, whereby positions in the X direction, the Y direction, and the Z-axis rotation direction are determined. In addition, the slope portions 17b and the slope portions 18b can slide on each other no matter which positions they are located on the side surfaces of the connector. The other positioning methods are the same as in the connector device of embodiment 1 and therefore the description thereof is omitted here.

### Embodiment 4

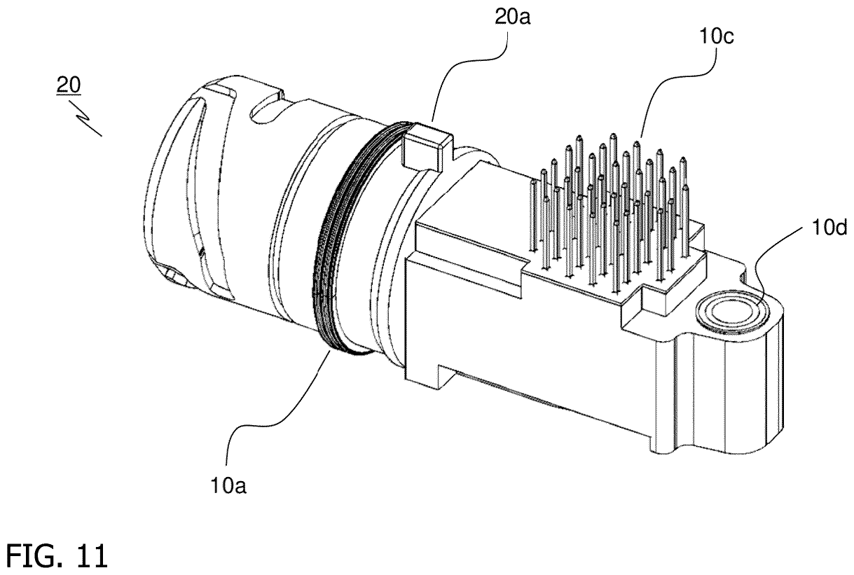

Hereinafter, a connector device 22 of embodiment 4 will be described with reference to FIG. 11 to FIG. 13. The basic structure of the connector device is the same as that of the connector device of embodiment 1 and therefore only difference will be described below.

A connector 20 (hereinafter, may be referred to as waterproof connector 20) used in the connector device of embodiment 4 shown in FIG. 11 includes a protrusion 20a as a position setting determination portion.

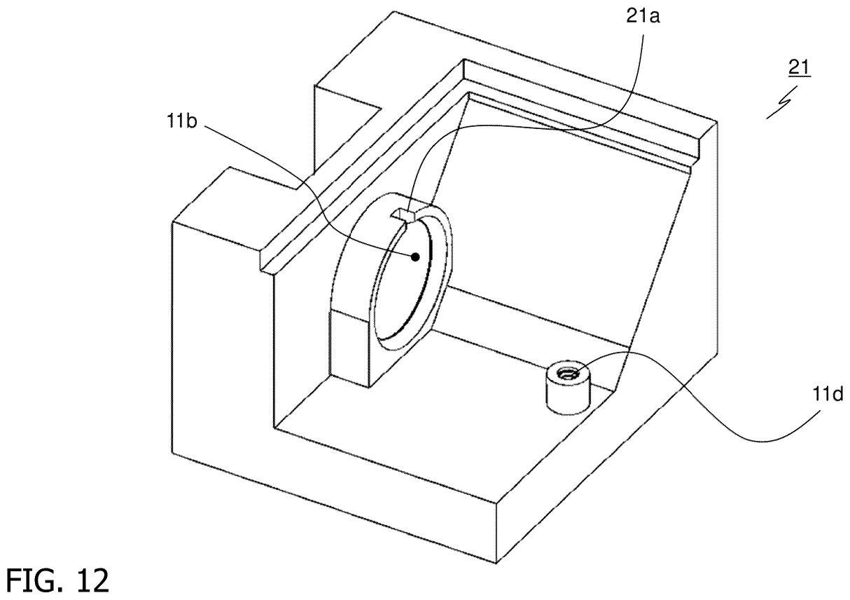

A housing 21 used for the connector device of embodiment 4 shown in FIG. 12 includes a contact surface 21a to contact with the protrusion 20a so as to surround the protrusion 20a.

A circuit board used in the connector device of embodiment 4 has the same structure as the circuit board used in the connector device of embodiment 1 and therefore the description thereof is omitted here.

### Connector Positioning Method

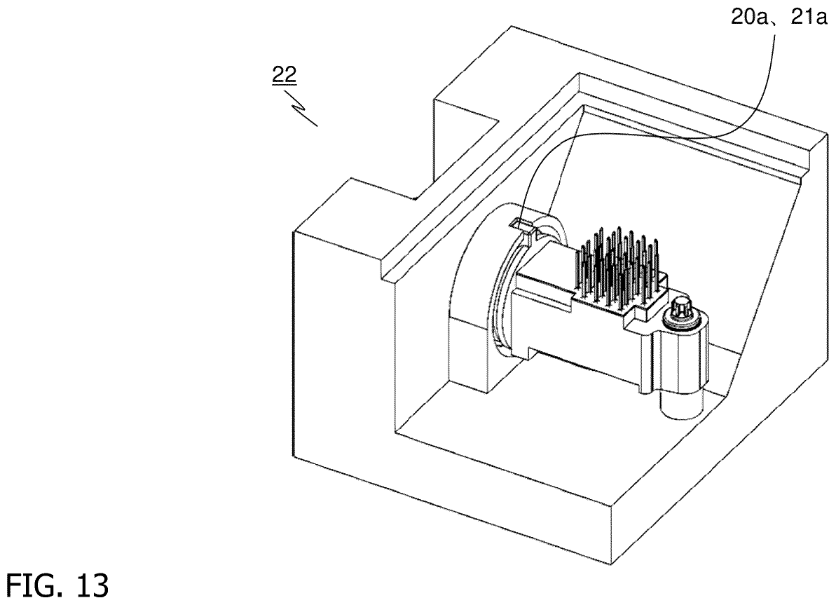

A positioning method for the connector 20 of the connector device 22 of embodiment 4 will be described with reference to FIG. 13.

In attaching the connector 20 to the housing 21, the protrusion 20a which is a position setting determination portion of the connector 20 contacts with the contact surface 21a which is the positioning portion of the housing 21, whereby positions in the X direction, the Y direction, and the Z-axis rotation (rotation about Z-axis) direction are determined.

At this time, the protrusion-recess relationship between the position setting determination portion and the positioning portion may be reversed. The other positioning methods are the same as in embodiment 1 and therefore the description thereof is omitted here.

### Embodiment 5

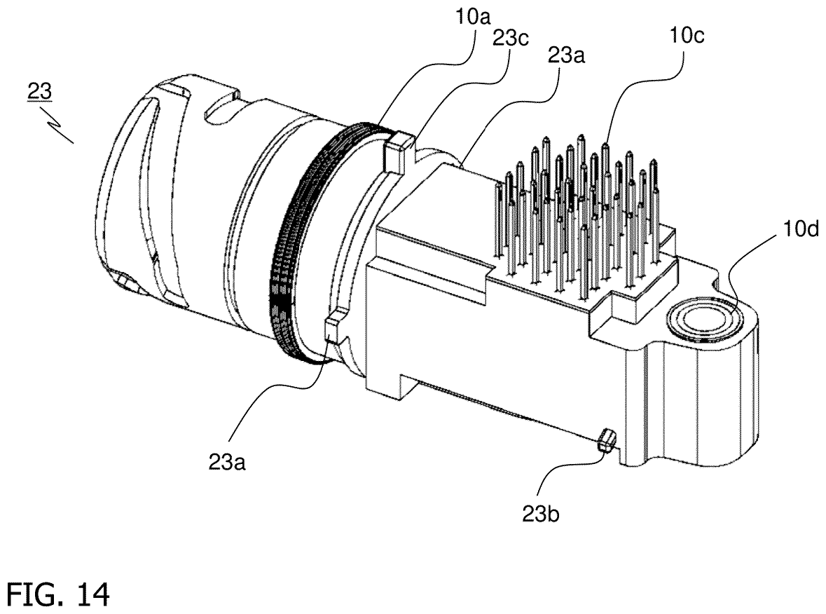

Hereinafter, a connector device 25 of embodiment 5 will be described with reference to FIG. 14 to FIG. 16. The basic structure of the connector device 25 is the same as that of the connector device of embodiment 1 and therefore only difference will be described below.

The connector 23 (hereinafter, may be referred to as waterproof connector 23) used for the connector device 25 of embodiment 5 shown in FIG. 14 includes, as position setting determination portions, protrusions 23a, 23b, and 23c (which may be referred to as positioning protrusions 23a, 23b, and 23c) provided at three locations on a connector side surface.

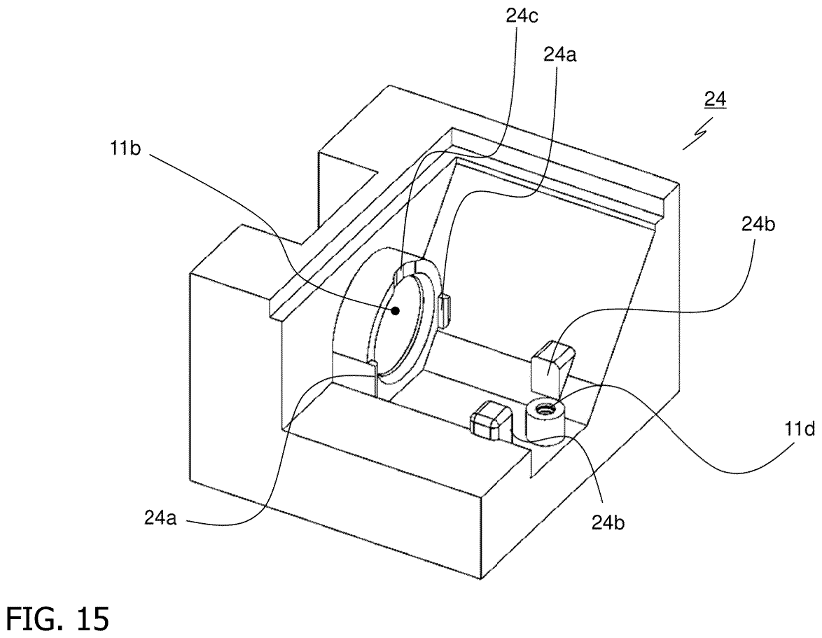

The housing 24 used for the connector device 25 of embodiment 5 shown in FIG. 15 includes a surface 24a to contact with the protrusion 23a, a surface 24b to contact with the protrusion 23b, and a surface 24c to contact with the protrusion 23c.

A circuit board used in the connector device 25 of embodiment 5 has the same structure as the circuit board used in the connector device of embodiment 1 and therefore the description thereof is omitted.

### Connector Positioning Method

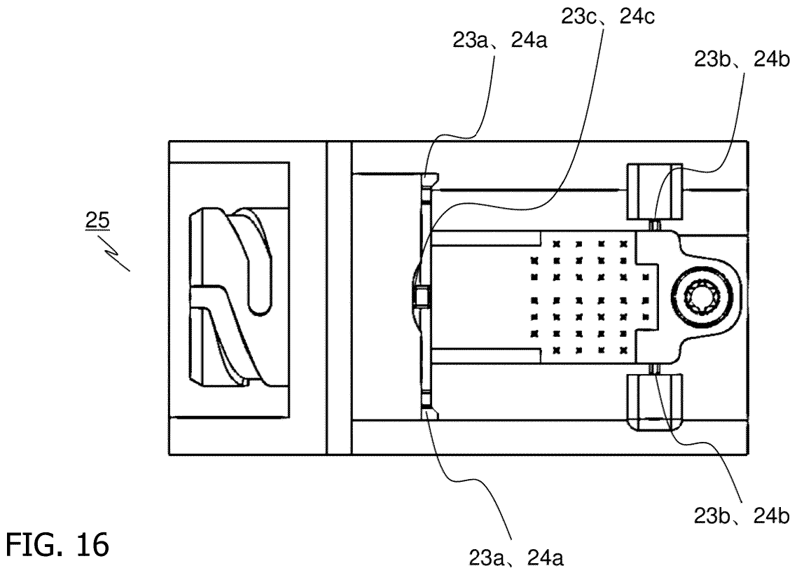

Hereinafter, a positioning method for the connector 23 of the connector device 25 of embodiment 5 will be described with reference to FIG. 16.

In attaching the connector 23, as the position setting determination portions, the protrusion 23a contacts with the surface 24a, whereby a position in the Z-axis rotation direction is determined, the protrusion 23b contacts with the surface 24b, whereby a position in the Y direction is determined, and the protrusion 23c contacts with the surface 24c of the housing 24, whereby a position in the X direction is determined.

The other positioning methods are the same as in the connector device of embodiment 1 and therefore the description thereof is omitted here.

### Embodiment 6

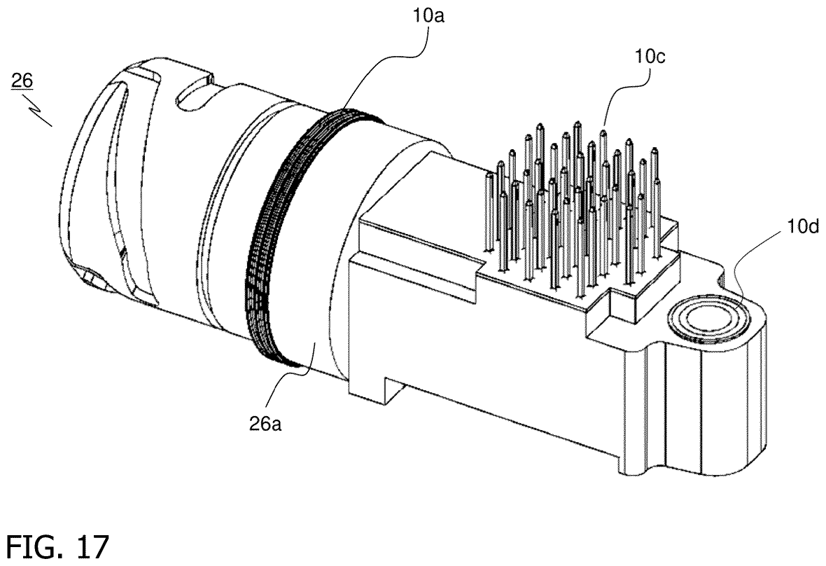

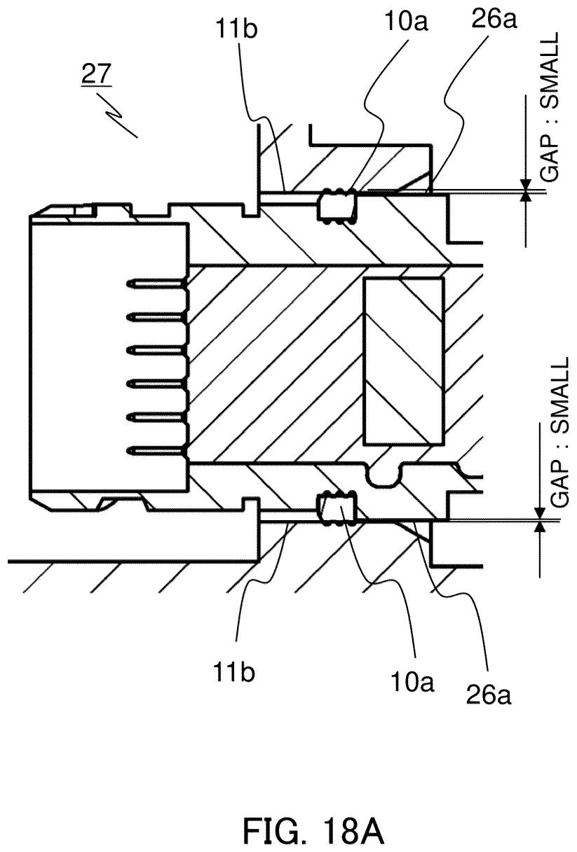

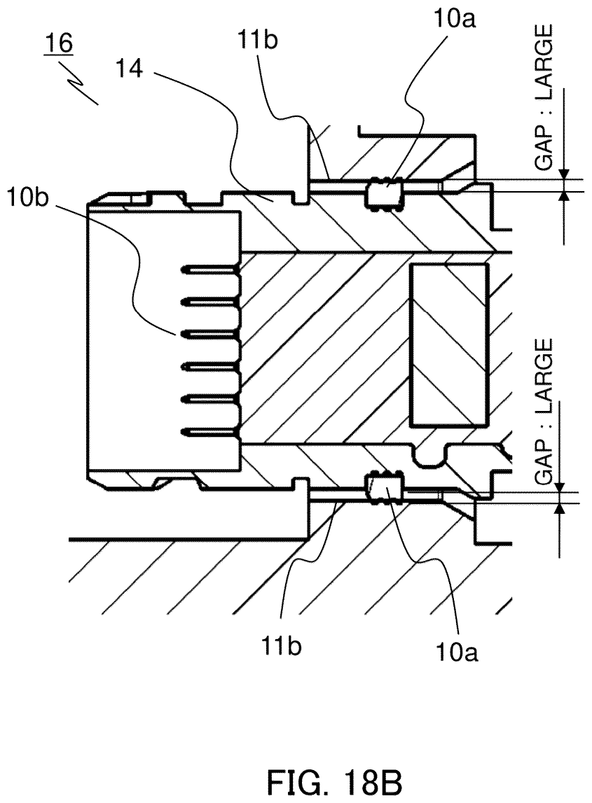

Hereinafter, a connector device of embodiment 6 will be described with reference to FIG. 17 to FIG. 18B. The basic structure of the connector device of embodiment 6 is the same as that of the connector device of embodiment 1 and therefore only difference will be described.

A connector 26 (hereinafter, may be referred to as waterproof connector 26) used for a connector device 27 of embodiment 6 shown in FIG. 17 includes, as a position setting determination portion, a contact surface 26a to contact with the seal surface 11b of the housing used for the connector device of embodiment 6, at a cylindrical part of the connector.

The housing used for the connector device of embodiment 6 has the same structure as the connector device of embodiment 1 and therefore the description thereof is omitted here.

The circuit board used in the connector device of embodiment 6 has the same structure as the connector device of embodiment 1 and the description thereof is omitted here.

### Connector Positioning Method

Hereinafter, a positioning method for the connector 26 of the connector device 27 of embodiment 6 will be described with reference to FIG. 18A and FIG. 18B. Here, FIG. 18A is a sectional view of a seal part of the connector device 27 of embodiment 6, and for comparison with the above sectional view, FIG. 18B (the same view as FIG. 7B) shows a sectional view of a seal part of the connector device 16 of embodiment 2. As is found from these drawings, the size of the gap at the seal part between the housing and the connector of the connector device 27 of embodiment 6 is set to be smaller than the size of the gap at the seal part of the connector device 16 of embodiment 2. That is, specifically, in attaching the connector 26 to the housing, the seal surface 11b of the housing contacts with the contact surface 26a of the connector, whereby positions in the Y direction and the Z-axis rotation direction are determined. Positioning in the X direction is the same as in the other embodiments described above. The other positioning methods are the same as in the connector device of embodiment 1 and therefore the description thereof is omitted here.

### Embodiment 7

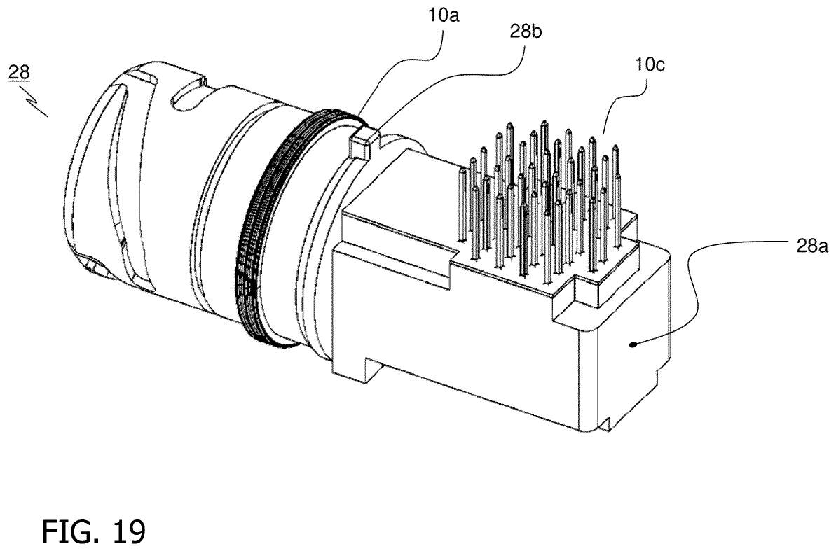

Hereinafter, a connector device of embodiment 7 will be described with reference to FIG. 19 to FIG. 21. The basic structure of the connector device of embodiment 7 is the same as that of the connector device of embodiment 1 and therefore only difference will be described.

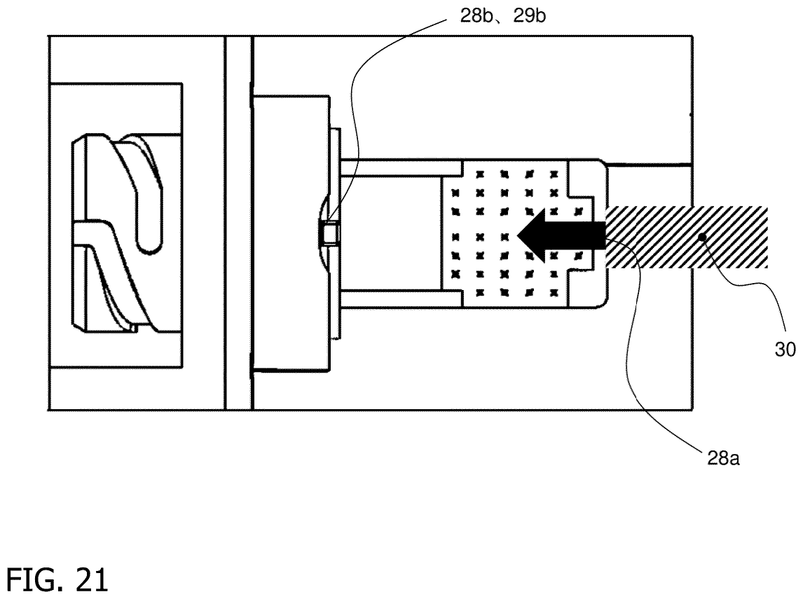

A connector 28 (hereinafter, may be referred to as waterproof connector 28) used for the connector device of embodiment 7 shown in FIG. 19 includes a surface 28a for receiving a force from an elastic member 30 shown in FIG. 21, and a protrusion 28b as a position setting determination portion.

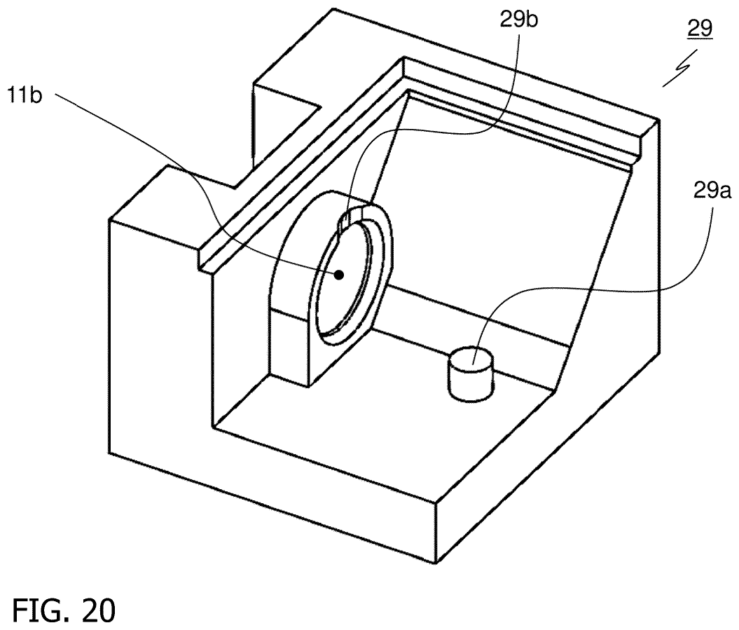

A housing 29 used for the connector device of embodiment 7 shown in FIG. 20 includes a boss 29a for supporting the waterproof connector 28, and a surface 29b to contact with the protrusion 28b, as a position determination portion.

The circuit board used in the connector device of embodiment 7 has the same structure as the connector device of embodiment 1 and therefore the description thereof is omitted here.

### Connector Positioning Method

Hereinafter, a positioning method for the connector 28 of the connector device of embodiment 7 will be described with reference to FIG. 21.

In the connector device of embodiment 7, the connector fixation method is different from that in the connector device of embodiment 1 and is changed from screw-fastening to a method of fixing the connector to the housing 29 by a pressing force from the elastic member 30, which is an external force. Therefore, there is no bush 10d for screw-fastening, and instead, the surface 28a (pressing surface 28a) provided to the connector 28 contacts with the elastic member 30 and the protrusion 28b of the connector 28 is pressed against the surface 29b of the housing 29, whereby positions in the X direction, the Y direction, and the Z-axis rotation direction are determined. Regarding the Z direction, the X-axis rotation direction, and the Y-axis rotation direction, positions are determined by the waterproof connector 28 and the boss 29a of the housing 29 contacting with each other.

### Embodiment 8

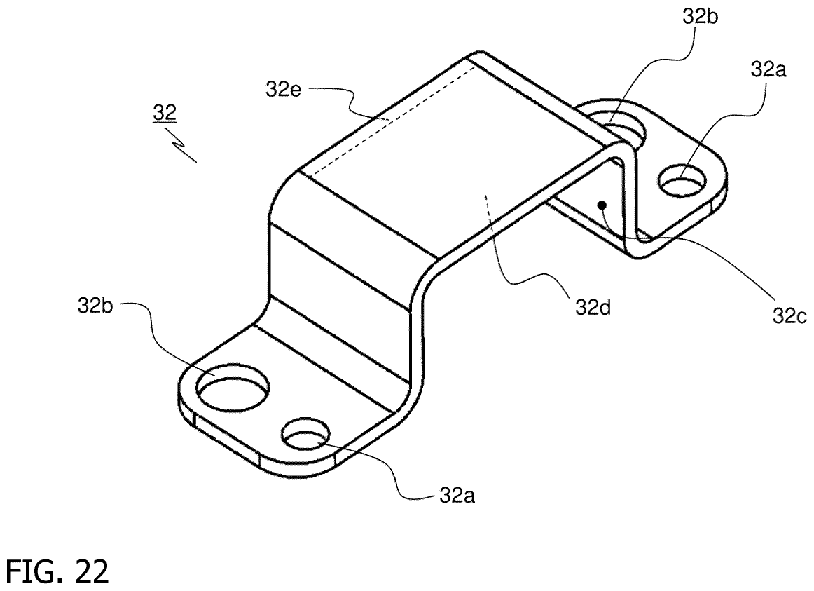

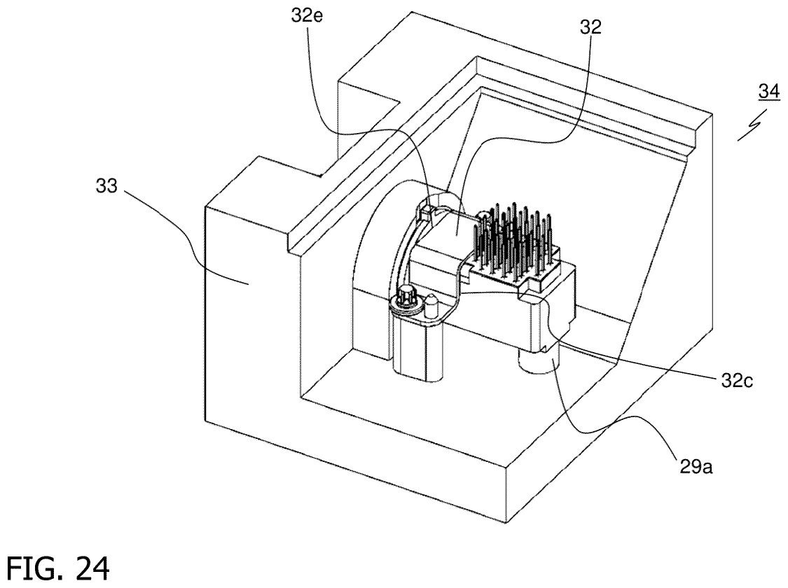

Hereinafter, a connector device 34 of embodiment 8 will be described with reference to FIG. 22 to FIG. 24. The basic structure of the connector device of embodiment 8 is the same as that of the connector device of embodiment 1 and therefore only difference will be described below.

A bracket 32 used for the connector device 34 of embodiment 8 shown in FIG. 22 has a leg portion, and the leg portion has positioning holes 32a at two locations, and screw holes 32b at two locations for fixing the connector used for the connector device of embodiment 8. In attaching the connector to the housing used for the connector device of embodiment 8, a bracket surface 32c, a bracket surface 32d, and a bracket surface 32e provided to the bracket 32 contact with the connector. Here, the bracket surface 32e is a side surface of the bracket 32 perpendicular to the bracket surface 32d which is a back-side flat surface of the bracket 32.

A connector (hereinafter, may be referred to as waterproof connector) used for the connector device 34 of embodiment 8 has the same structure as the connector of embodiment 7 (the basic structure is the same as that in embodiment 1) and therefore the description thereof is omitted here.

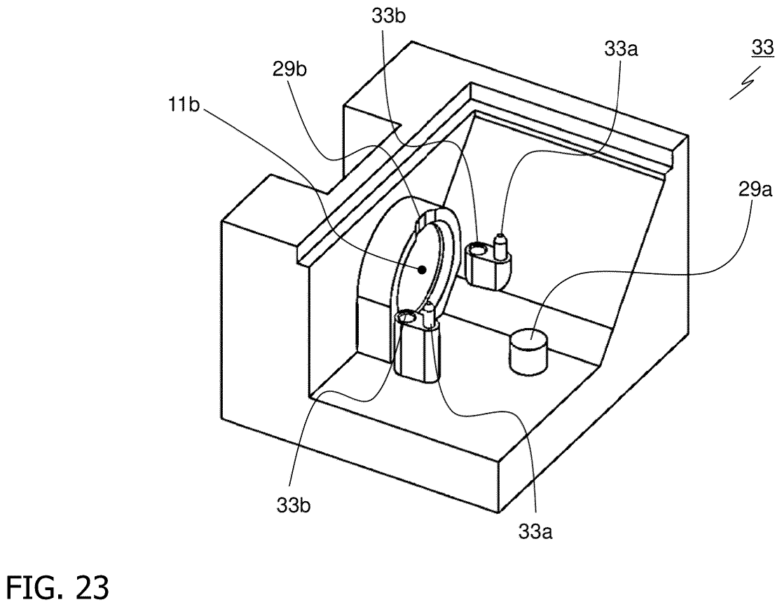

A housing 33 used for the connector device 34 of embodiment 8 shown in FIG. 23 includes positioning pins 33a extending in the Z direction at two locations and internal threads 33b for screw-fixation at two locations, and includes the boss 29a for supporting the connector as in the connector device of embodiment 7.

A circuit board used in the connector device of embodiment 8 has the same structure as the circuit board used in the connector device of embodiment 1 and therefore the description thereof is omitted here.

### Connector Positioning Method

Hereinafter, a positioning method for the connector of the connector device 34 of embodiment 8 will be described with reference to FIG. 22 to FIG. 24.

In attaching the connector of the connector device 34 of embodiment 8 to the housing, the positioning holes 32a of the bracket 32 are attached with the positioning pins 33a of the housing inserted therethrough and then screws are fastened to the internal threads 33b at two locations, whereby the connector is fixed to the housing 33.

At this time, the connector and the bracket surface 32e contact with each other, whereby a position in the X direction is determined, and the connector side surface and the bracket surface 32c contact with each other, whereby positions in the Y direction and the Z-axis rotation direction are determined. The other positioning is made by contact between the connector and the boss 29a for supporting the connector as in the connector device of embodiment 4.

The above description has been given under the assumption that the connector and the bracket are formed by separate members, but without limitation thereto, the connector and the bracket may be integrally molded.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

10 connector (waterproof connector)
100 connector device
10a seal packing
10b, 10c connection terminal
10d bush
10e position setting determination portion
11 housing
11a fit-in hole
11b seal surface
11c boss
11d internal thread
11e positioning portion
12 circuit board
13 positioning pin

1. A connector device comprising:
a housing in which a connector is provided; and
a circuit board which transmits information from an electronic device fixed inside the housing, wherein
the connector has a seal packing for waterproofing, a first connection terminal to be connected to an external circuit, a second connection terminal to be connected to the circuit board, a fastening portion to the housing, and a position setting determination portion to determine a set position relative to the housing,
the housing has a fit-in hole into which an end of the connector is fitted, a fastening portion to the connector, and a positioning portion to determine a placement position of the connector on the housing, and
the connector is fixed by being fitted into the fit-in hole of the housing with the seal packing interposed therebetween, and a position of the connector relative to the housing is set by the position setting determination portion of the connector and the positioning portion of the housing.

2. The connector device according to claim 1, wherein
the position setting determination portion of the connector includes at least two positioning holes or positioning pins, and the positioning portion of the housing has at least one flat surface for positioning the connector.

3. The connector device according to claim 1, wherein
the connector has a flange and at least two slope portions, for positioning to the housing.

4. The connector device according to claim 1, wherein
the position setting determination portion of the connector has at least two positioning protrusions for positioning to the housing, and the positioning protrusions have surfaces to oppose the positioning portion of the housing.

5. The connector device according to claim 1, wherein
the connector has a pressing surface which is to be pressed by an external force and which is different from the position setting determination portion, and the connector is positioned by the pressing surface being pressed by the external force.

6. The connector device according to claim 1, wherein
the connector has, as the position setting determination portion, a contact surface to contact with a seal surface of the fit-in hole, at a cylindrical part of the connector.

7. The connector device according to claim 1, further comprising a bracket formed as a separate member or integrally molded with the connector, the bracket having a leg portion, wherein
the bracket is placed with the leg portion opposing the positioning portion of the housing, and the bracket is fixed by the positioning portion of the housing.
